(19) United States
(12) Patent Application Publication
(10) Pub. No.: US 2012/0254760 A1
(43) Pub. Date: Oct. 4, 2012

(54) SYSTEM AND METHOD FOR ACCELERATING CONTENT GENERATION FOR SELECTED CONTENT

(76) Inventors: Douglas C. Meeker, Aldie, VA (US); Karen L. Kuhne, Denver, CO (US); Erin K. McCue, Denver, CO (US); Joshua Futterman, Denver, CO (US); James Matthew Saunders, Westminster, CO (US); David Soloff, Berkeley, CA (US); Thomas P. Woerner, Chatham, NJ (US)

(21) Appl. No.: 13/331,917

(22) Filed: Dec. 20, 2011

Related U.S. Application Data
(60) Provisional application No. 61/470,832, filed on Apr. 1, 2011.

(51) Int. Cl. G06F 3/01

(52) U.S. Cl. 715/733

(57) ABSTRACT

According to embodiments of the invention, a computer system extends an invitation to a plurality of content generators to request authentic content relating to one or more selected topics. The computer system receives content generated in response to the invitation and publishes that content online. The computer system calculates an efficacy of the request by obtaining data regarding to the online content and user interactions with the content. The computer system is configured to obtain data corresponding to user interactions with the content on the website hosting the content as well as user interactions with the content on third party websites such as Facebook® or Twitter®. Using that data, the computer system calculates an efficacy of the request. The computer system may also generate one or more reports to convey the calculated efficacy of the request.

### CROSS REFERENCE TO RELATED APPLICATIONS

The present application claims priority to U.S. Provisional Patent Application No. 61/470,832, filed on Apr. 1, 2011, the content of which is incorporated by reference in its entirety.

### BACKGROUND/TECHNICAL FIELD

Several embodiments of the invention relate to publishing content online and in particular to automatically analyzing the efficacy of a request to create select content.

### SUMMARY

According to several embodiments of the present invention, an automated system sends a request to a plurality of content generators to generate online content relating to a selected topic. Then, the automated system obtains data relating to the generated online content, such as data corresponding to user interactions with the online content. For example, the automated system may harvest data corresponding to user interactions with the content on social media websites, such as the number of Facebook® “likes” or Twitter® “tweets.” The automated system may also harvest data corresponding to user interactions with the content on websites incorporating the content, for example, the number of user comments on the article, as well as data regarding the content itself, for example, the amount of content created in response to the request. The automated system uses that data to calculate an efficacy of the request and populates a report to visually display the efficacy of the request.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates a networked environment in which embodiments of the present invention may operate.

FIG. 2A illustrates an exemplary computer in accordance with embodiments of the present invention.

FIG. 2B illustrates an exemplary computer server in accordance with embodiments of the present invention.

FIG. 3 illustrates a flow chart depicting steps for accelerating content generation envisioned by embodiments of the present invention.

FIG. 4 illustrates a flow chart illustrating steps for processing requests and content that may be taken by the Primary System of FIG. 3, according to embodiments of the present invention.

FIG. 5 illustrates a flow chart illustrating steps for creating a report that may be taken by the Secondary System of FIG. 3, according to embodiments of the present invention.

FIG. 6 illustrates a portion of a first exemplary report according to embodiments of the invention.

FIG. 7 illustrates a portion of a second exemplary report according to embodiments of the invention.

FIG. 8 illustrates a portion of a third exemplary report according to embodiments of the invention.

FIG. 9 illustrates a portion of a fourth exemplary report according to embodiments of the invention.

FIG. 10 illustrates a portion of a fifth exemplary report according to embodiments of the invention.

FIG. 11 illustrates a flow chart depicting steps for evaluating the efficacy of a request according to embodiments of the present invention.

FIG. 12 illustrates a flow chart depicting steps for organizing a campaign according to embodiments of the present invention.

### DETAILED DESCRIPTION

According to embodiments of the invention, an automated system sends out a request to a plurality of content generators (e.g., authors) to create authentic online content relating to a specific topic. The content generators may be freelance writers that have been previously approved to receive the request. The request may be general in nature, e.g., an invitation to create content related to cars, or it may be more specific, e.g., an invitation to create content related to a particular brand of pet food. The automated system collects data regarding content created in response to the request and also receives data detailing user interactions with the content. The user interactions with the content may occur on websites that include the content and may also occur on third-party websites, such as Facebook® or Twitter®. The automated system analyzes the data to determine the efficacy of the request and may also generate an analysis based on the efficacy of the request.

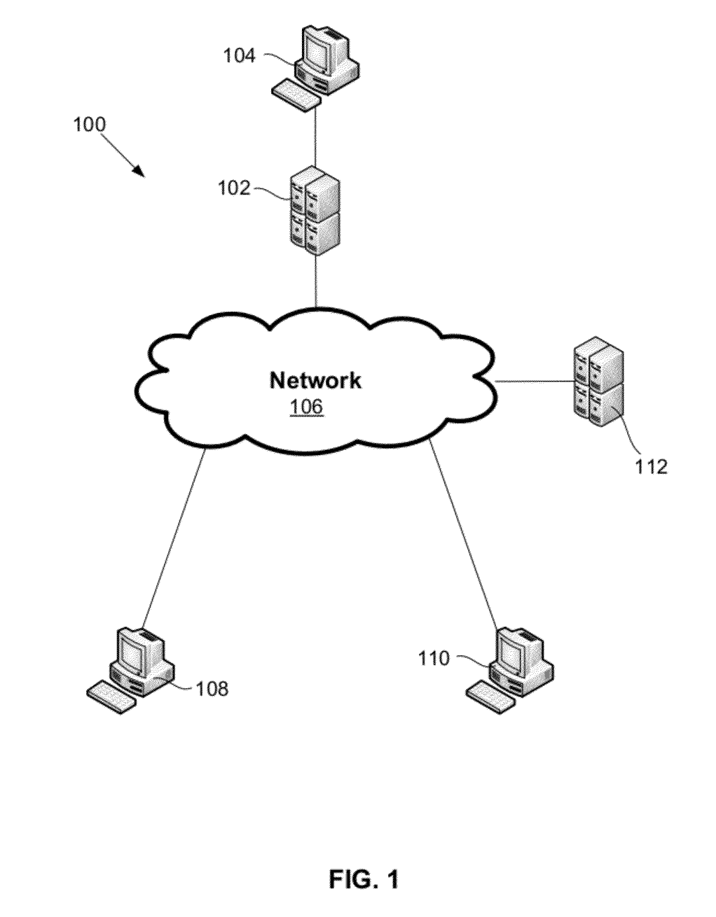

Several embodiments of the invention (as well as environments in which they operate) utilize multiple computers connected over a network, such as the Internet. As shown in FIG. 1, a networked environment 100 may include an operator server 102 and an operator computer 104. The operator server 102 and the operator computer 104 are connected to a network 106, such as the Internet. Also connected to the network are a content generator computer 108, a user computer 110, and a third party server 112. While FIG. 1 depicts a small networked environment, in many embodiments the networked environment 100 may include a plurality of operator servers 102, operator computers 104, networks 106, content generator computers 108, user computers 110, and/or third party servers 112. In several embodiments, the operator server 102 may host online content created by content generators using content generator computers 108 and provide that content to user computers 110 over the Internet.

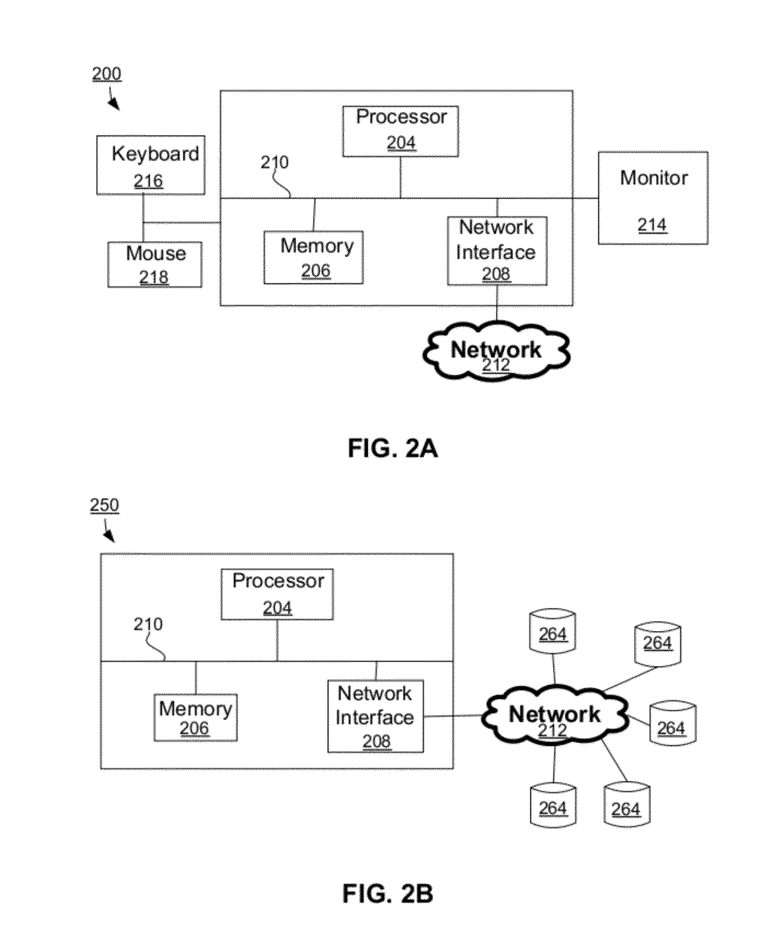

FIG. 2A illustrates portions of a computer system 200, which may serve as an operator computer 104, a content generator computer 108, and/or a user computer 110. The illustrated computer system 200 includes a processor 204 coupled to a memory 206 and network interface 208 through a bus 210. The network interface 208 is also coupled to a network 212 such as the Internet. The computer system 200 may further include a monitor 214, a keyboard 216, and a mouse 218. In other embodiments, the computer system 200 may use other mechanisms for data input/output and may include a plurality of components (e.g., a plurality of memories 206 or buses 210). FIG. 2B illustrates portions of a computer server 250, which may serve as an operator server 102. The illustrated computer server 250 includes a processor 204 coupled to a memory 206 and network interface 208 through a bus 210. The network interface 208 is also coupled to a network 212 such as the Internet. In other embodiments, the computer server 250 may include a plurality of components (e.g., a plurality of memories 206 or buses 210). The network 212 may include a remote data storage system including a plurality of remote storage units 264 configured to store data at remote locations. Each remote storage unit 264 may be network addressable storage.

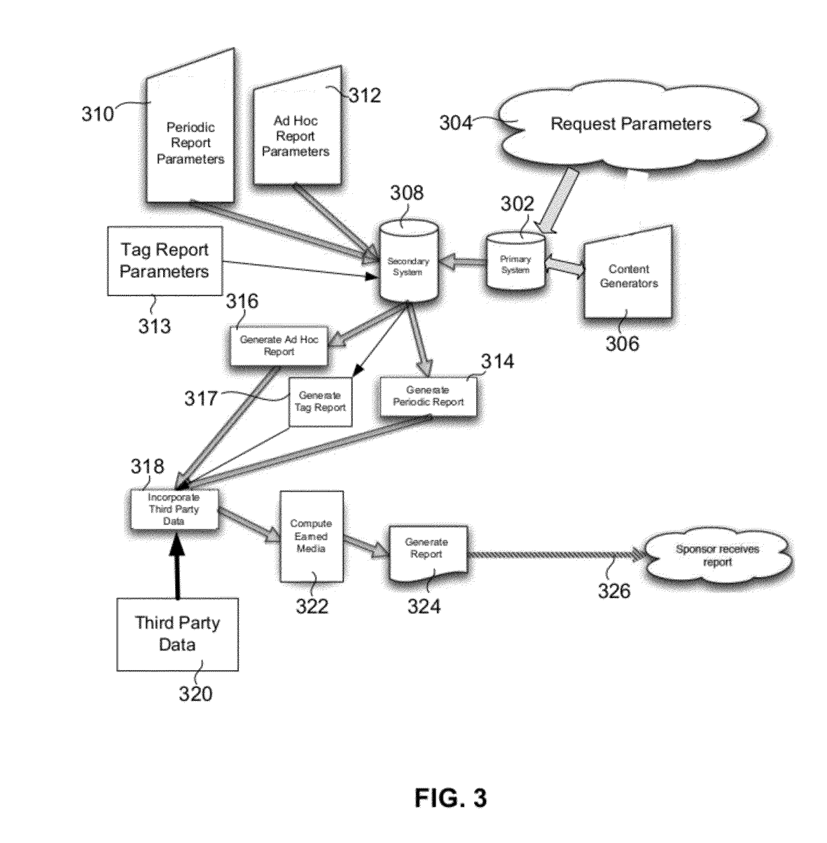

In the embodiments shown in FIG. 3, the Primary System 302, which may correspond to the operator server 102, receives request parameters 304. The request parameters 304 are used to generate an invitation to create content, and may specify who is sponsoring the content, tags or key words the content generators should use when creating the content, which content generators should receive the request or how the content generators should be selected, and/or the topic(s) to which the content should relate. The content generators may be selected based on particular expertise or location. Other factors that may be used when selecting content generators include the quality of content previously created, the relevance of prior content to the selected topic, or the overall performance of the content generators in creating prior content. In some embodiments, the tags may be metadata associated with the content, while in other embodiments the tags may be certain words or phrases that content generators place in the content itself. The request parameters 304 may also include whether the content generator should flag the content as created in response to the request. In addition, the request parameters 304 may include the time period during which the content should be created. Various combinations of these and other parameters may be included according to various embodiments of the invention. In other embodiments, an operator computer 104 or other device may receive the request parameters and send the request.

Using the request parameters 304, the Primary System 302 sends a request to the designated content generators (shown as block 306), who may respond to the request and generate content. In other embodiments, an operator computer 104 or other device may send the request. Thus, the Primary System 302 or the operator computer 104, among others, may operate as an invitation generator and/or an invitation conveyer. In addition, multiple requests may be sent for the creation of additional content on the topic, on a sub-topic, or on a topic related to the original topic.

In some embodiments, the Primary System 302 contains information on a large group of content generators, e.g., as many as 70,000. That information may include areas of expertise, locality, prior content, number of readers, etc., which may be used to select the content generators that receive the request. That information may also be used to send out a request to thousands of content generators without needing to identify them individually. In other embodiments, the request parameters specify a discrete set of content generators to whom the Primary System 302 sends a request. Having content generator information in the Primary System 302 may facilitate the tracking and monitoring of content that is created in response to a request.

In some embodiments, the Primary System 302 may host the content created by the content generators in response to the request, while in other embodiments a different server may host the content and provide the Primary System 302 with access to the content. In those embodiments in which the content is hosted by the Primary System or by systems associated with the Primary System, the Primary System can quickly access and analyze the content created in response to the request. For example, the Primary System 302 may prompt content generators to flag content that was created in response to a request. The Primary System 302 may make the content accessible on Internet websites, and may also place sponsor advertisements near the content to create an association between the content and the sponsor. In some embodiments, the content generators are not required to respond to a request and are allowed to create content on any number of broad subjects related to the topic. This creates authentic and engaging content that contributes to a positive association between the content and the sponsor.

According to some embodiments, the content hosted by the Primary System 302 may be sent to a separate system, referred to as the “Secondary System” 308. However, the use of a Secondary System is only one example, and any system using any number of programs with similar functionality are also contemplated. In some embodiments, the Secondary System 308 includes a program running on a computer or server coupled to a database, and may include several of the components depicted in FIG. 2A or 2B. The Secondary System 308 may be constructed using an open source framework running, for example, a Linux operating system, and may use PHP, MongoDB®, MySQL®, and a framework such as Drupal® to perform some of the steps described herein. PHP is an open source scripting language and is available at http://www.php.net. MongoDB® is an open source, document-oriented database written in C++ and is available at http://www.mongodb.org. MySQL is an open source relational database written in C and C++ and is available at http://www.mysql.com. Drupal® is an open source content management platform and is available at http://drupal.org. At the same time, in other embodiments the Secondary System 308 may run on essentially any platform using essentially any coding language—the embodiments disclosed herein are merely given as examples.

The Primary System 302, in some embodiments, may host a large volume of content, only some of which is created in response to a request. In some embodiments, the Primary System 302 sends all of the content to the Secondary System 308, which will then use the tags, flags, and/or key words to identify content created in response to the request. Thus, in some embodiments, the Secondary System 308 serves as a receiver configured to obtain online content created in response to a request. In other embodiments, the Primary System 302 may use the tags, flags, and/or key words associated with the content to identify content created in response to a request and send only that content to the Secondary System 308. In yet other embodiments, the Primary System 302 does not export the content to a separate server but instead performs the operations described below.

The Secondary System 308, in some embodiments, receives periodic report parameters 310 and/or ad hoc report parameters 312. The periodic report parameters 310 and the ad hoc report parameters 312 define specific information that the Secondary System 308 later extracts from the content in order to evaluate the efficacy of the request and/or create a report. The primary difference between the periodic report parameters 310 and the ad hoc report parameters 312 is that the periodic report parameters 310 include information instructing the Secondary System 308 to periodically generate reports, while the ad hoc report parameters 312 instruct the Secondary System 308 to generate a report upon receipt or soon thereafter. The remaining parameters in the periodic report parameters 310 and the ad hoc report parameters 312 are essentially the same in some embodiments. For example, the parameters may instruct the Secondary System 308 to extract data regarding content generator identification, a title of the content, when the content was published, how many user comments were made on a webpage containing the content, etc. The report parameters may also require information regarding user interactions with the content, such as number of page views or content generator subscriptions. The Secondary System 308 may also receive tag report parameters 313 that instruct the Secondary System 308 to extract data regarding the number of times particular tags are used, among other information, when generating a report. The tag report parameters may direct the Secondary System 308 to periodically generate reports or to generate a report upon receipt or shortly thereafter.

In the embodiments shown in FIG. 3, the periodic report parameters 310 instruct the Secondary System 308 to create a report on a daily basis, e.g., at midnight. Following those instructions, the Secondary System 308 schedules a report generating process that generates a periodic report, as shown at block 314. The Secondary System 308 may also be configured to check for receipt of the ad hoc report parameters 312 at a set frequency, e.g., every minute, and generate an ad hoc report, as shown at block 316. Likewise, the tag report parameters 313 may instruct the Secondary System 308 to create a tag report detailing the use of tags with the content on a periodic basis or upon receipt, as shown at block 317.

Either in an ad hoc or in a scheduled fashion, the Secondary System 308 generates, or parses, one or more reports according to the report parameters 310, 312, and/or 313. Specifically, when creating the reports, the Secondary System 308 extracts, from the content, those parameters identified in the report parameters 310, 312, and/or 313. In addition, the Secondary System 308 may incorporate into the report data received from third parties, as shown at blocks 318 and 320. That data may correspond to user interactions with the content on third-party websites, such as Twitter® or Facebook®, or may correspond to user interactions with the content itself, such as data collected by a third-party regarding the number of page views of websites containing the content. Thus, the Secondary System 308 may serve as an analyzer to determine the efficacy of the request based, at least in part, on data corresponding to user interactions with the online content. The third party data may include the number of times the content was viewed, or the number of users that were directed to the sponsor's webpage by the content and/or by advertisements on the websites containing the content. The specific information received and incorporated from the third-party data into the report may be controlled by the report parameters 310, 312 and/or 313. In other embodiments, some or all of the data described above is harvested by the Secondary System 308 itself, or by a system associated with the Secondary System 308, rather than by third parties.

The Secondary System 308 may extract the parameters from the content using the code reproduced below. Thus, in some embodiments, the Secondary System 308 serves as a receiver configured to obtain data corresponding to user interactions with the online content. Code is provided as an example and the embodiments of the present invention should not be limited to the algorithms discussed herein.

For example, when processing the adhoc reports, the Secondary System 308 may employ the following:

<code>
$query = array(

‘processed’ => 0,
‘scheduled’ => 0,
‘queue’ => 1,
‘date_end’ => array(

‘$lte’ => REQUEST_TIME,

),

);
$collection = ‘parc_reports.’ . $type . ‘_reports’;
$record = mongodb( )−>command(

```
array(
  ‘findandmodify’ => $collection,
  ‘query’ => $query,
  ‘update’ => array(
```

‘$set’ => array(

‘processed’ => 1,

),

),
‘new’ => FALSE,

)

);
</code>

Using that code, the Secondary System 308 retrieves all reports that are ad hoc. The Secondary System also retrieves reports that are scheduled for processing or have reached the end date of the reporting period and have not yet been processed. Once the report has been retrieved, it is marked as having been processed to stop it being processed multiple times.

For scheduled reports, the Secondary System 308 may employ the following:

<code>
$query = array(

‘scheduled’ => 1,
‘date_end’ => array(

‘$gt’ => $run_date,

),

);
$fields = array(

‘title’ => 1,
‘date_start’ => 1,
‘date_end’=> 1,
‘period’ => 1,
‘frequency’ => 1,
‘runday’ => 1,
‘month_day’ => 1,
‘last_run’=> 1,

);
if ($type == ‘tag’) {

$field = ‘tags’;

}
else {

$field = ‘etids’;

}
$fields[$field] = 1;
$results = mongodb_collection(‘parc_reports’, $type . ‘_reports’)

−>find($query, $fields);

</code>

Using that code, the Secondary System 308 pulls all scheduled reports that have not reached the end day specified. Each report record is then checked to see if its start date has yet been reached. The frequency of the report is then checked, and a determination is made as to whether or not the scheduled report needs to run on a given day. If the report meets the criteria, then the appropriate report type is generated (e.g., sponsorship or tag).

The Secondary System 308 may also utilize the following:

<code>
$update = array(

‘$set’ => array(

‘last_run’ => (int) $adjusted_rundate,

),

);
$result = mongodb_collection(‘parc_reports’, $type . ‘_reports’)

−>update(array(‘_id’ => $result[‘_id’]), $update, array(‘safe’ =>
TRUE));

</code>

Under that code, if a report was generated that was assigned to run every n days, the date that the report was last produced is updated.

The Secondary System 308, in some embodiments, may employ different code to create reports from the report parameters 310 than from the report parameters 313. For reports using the report parameters 310 to track and report on a number of identifications, which may include, for example, content generator identifications or content identifications, the Secondary System 308 may utilize the following:

<code>
$query = array(

‘report_date’ => array(

‘$gte’ => (int) $start_date,
‘$lte’ => (int) $end_date,

),
‘etid’ => (int) $etid,

);
$fields = array(

‘views’ => TRUE,

);
$results = mongodb_collection(‘fields_current’, ‘parc_omniture’)

−>find($query, $fields);

</code>

In addition, the Secondary System 308 may extract the number of page views by retrieving all the page view records for the time period being reported on and for the identification being processed, using the following:

<code>
$query = array(

‘_id’ => (int) $etid,

);
$fields = array(

‘uid’=> 1,
‘term_tid’=> 1,

);
$ex_title = mongodb_collection(‘fields_current’, ‘ex_title’)

−>findOne($query, $fields);

</code>

Additional information about the identification being processed is pulled back to allow for additional data queries related to the identification to be carried out. The data retrieved is used to find the users' profile name and human readable taxonomy names.

<code>
$query = array(

‘ex_node_group.value’ => EX_NODE_GROUP_ARTICLE,
‘status’ => 1,
‘examiner_title.tid’ => (int) $ex_title[‘term_tid’],
‘edition.tid’ => (int) $examiner_title[‘edition’],
‘channel.tid’ => (int) $examiner_title[‘channel’],
‘uid’ => (int) $ex_title[‘uid’],
‘first_published.value’ => array(

‘$gte’ => (int) $start_date,
‘$lte’ => (int) $end_date,

),

);
$fields = array(

‘title’ => 1,
‘first_published.value’ => 1,
‘tag_summary’ => 1,
‘sponsor_program’ => 1,

);
$nodes = mongodb_collection(‘fields_current’, ‘node’)

−>find($query, $fields)
−>sort(array(‘first_published.value’ => −1));

</code>

A list of nodes may be retrieved that includes nodes related to the identification being processed and created in the time span at issue. Each node is also checked to see if the user that created it indicated that it should be included in reports. The real name of each tag on the node is also recorded.

<code>
$query = new EntityFieldQuery;
$comments = $query

−>entityCondition(‘entity_type’, ‘comment’)
−>propertyCondition(‘nid’, (int) $node[‘_id’])
−>propertyCondition(‘status’, 1)
−>propertyCondition(‘created’, array($start_date, $end_date),
‘BETWEEN’)
−>count( )
−>execute( );

</code>

The number of comments associated with the nodes that have been created in the time period in question may then be determined.

<code>
$query = array(

‘nid’ => (int) $nid,

);
$fields = array(

‘comment_timestamps’ => 1,
‘nid’ => 1,

);
return mongodb_collection(‘fb_comment_stats’)
−>find($query, $fields);
</code>

If no Drupal® comments are found, the Secondary System 308 may check to see if the node has any Facebook® comments associated with it that were created in the time period in question.

Once the Secondary System 308 has the required information, a row is generated for each node and this is written to a CSV file for later consumption by the sponsor.

When extracting data according to the tag report parameters 313, which may involve tracking a number of tags, the Secondary System 308 may employ the following:

<code>
$query = array(

‘_bundle’ => ‘channels_and_tags’,
‘name’ => new MongoRegex(‘/\hat{ }’ . trim($tag) . ‘$/i’),

);
$fields = array(

‘_id’ => 1,

);
$terms = mongodb_collection(‘fields_current’, ‘taxonomy_term’)

−>find($query, $fields);

</code>

A list of terms is retrieved that matches the tag in question, and the tag is checked in a case insensitive manner. Once the Secondary System 308 gets a list of term identifications that match the tag in question, it processes each term in turn.

<code>
$query = array(

‘tag_summary.tid’ => (int) $tid,
‘ex_node_group.value’ => EX_NODE_GROUP_ARTICLE,
‘status’ => 1,
‘first_publish.value’ => array(

‘$lte’ => (int) $end_date,
‘$gte’ => (int) $start_date,

),

);
$fields = array(

‘uid’ => 1,
‘primary_tag.tid’ => 1,
‘secondary_tags.tid’ => 1,

);
$nodes = mongodb_collection(‘fields_current’, ‘node’)

−>find($query, $fields);

</code>

For each term identification the Secondary System 308 may pull back a list of nodes that have been tagged with the term in question and was published in the time frame that is being processed. The node is then examined to ensure that the term is a specific type of tag, and if this is the case, it is processed. The node that the Secondary System 308 is processing is stored in an array for future processing if required.

<code>
$query = new EntityFieldQuery;
$comments = $query

−>entityCondition(‘entity_type’, ‘comment’)
−>propertyCondition(‘nid’, (int) $node[‘_id’])
−>propertyCondition(‘status’, 1)
−>propertyCondition(‘created’, array($start_date, $end_date),
‘BETWEEN’)
−>count( )
−>execute( );

</code>

The number of comments associated with the nodes that have been created in the time period in question is then determined.

<code>
$query = array(

‘nid’ => (int) $nid,

);
$fields = array(

‘comment_timestamps’ => 1,
‘nid’ => 1,

);
return mongodb_collection(‘fb_comment_stats’)
−>find($query, $fields);
</code>

If no Drupal® comments are found, the Secondary System 308 checks to see if the node has any Facebook® comments associated with it that were created in the time period in question.

Once a given tag is finished being processed, totals for the tag are calculated, which includes comments, nodes and user counts. A CSV file is then generated with these values for consumption by the sponsor.

<code>
$fields = array(

‘uid’ => 1,
‘edition.tid’ => 1,

‘channel.tid’ => 1,

);
$node = mongodb_collection(‘fields_current’, ‘node’)

−>findOne(array(‘_id’ => (int) $nid), $fields)

</code>

If a report has been flagged as providing an article breakdown, each node that has been recorded above is processed in turn, metadata is looked up (e.g., the content generator's name), and then the article is output to a CSV for consumption by the sponsor.

Thus, in some embodiments the report may include the following information about content created in response to the request: content generator identifications, content titles, number of content (e.g., articles) created, date each content was published, tags used with the content, specific terms mentioned in the content, number of page views per content, number of comments per content, the number of Facebook® “likes” involving the content, and/or the number of Twitter® “tweets” referencing the content, etc. The report may also include portions of the content created in response to the request, links to the websites containing the content, extracts from the website illustrating the content, and any advertisements or promotions, and/or images of user interaction with the content on third-party websites.

In some embodiments, the Secondary System 308 analyzes the data extracted from the online content and received from third parties to calculate an efficacy of the request. For example, the Secondary System 308 may compute an “earned media” value that reflects the efficacy of the request, as shown at block 322. In some embodiments the earned media value may be based in part on the number of content generators that created content, the amount or number of content created during the time period, and the number of user interactions with the content on third-party websites. That information is then correlated into a dollar value to compute the earned media value. In other embodiments, the efficacy of the request may simply involve the number of responses by content generators and by users to content created in response to a request. The efficacy of the request may be included in a report, as shown at block 324.

In some embodiments, the Secondary System 308 includes a Reporting Tool, which may display the report and/or may output the report in a format compatible with common software, such as CSV, as shown at block 324. The Secondary System 308 may then send out the report to the sponsor, as shown at block 326. In other embodiments, the Secondary System 308 may send the report to a separate system for further refinement before the information reaches the sponsor.

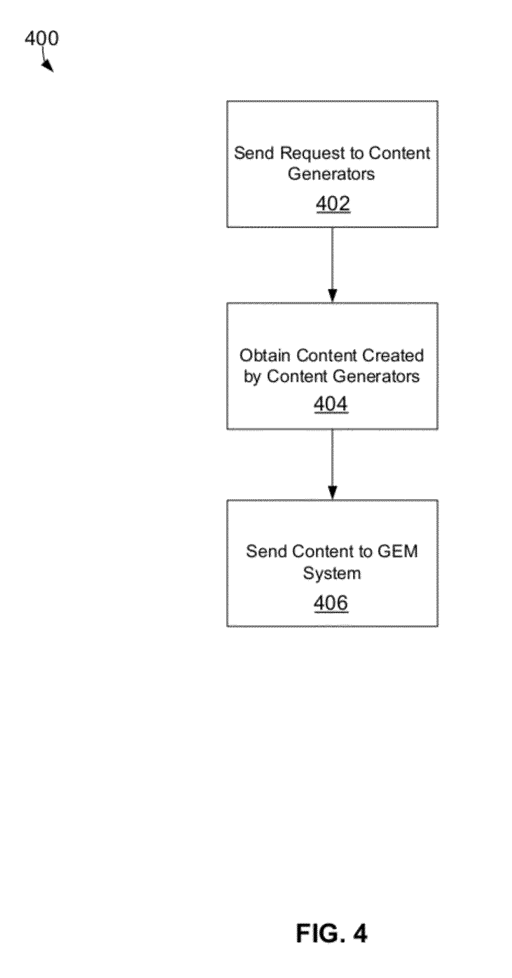

FIG. 4 illustrates an exemplary process 400 that may be performed by the operator server 102 or by the Primary System 302 according to embodiments of the invention. The operator server 102 sends an invitation, or request, to one or more content generators to create content related to a topic, as shown at block 402. In some embodiments, before sending the invitation to the content generators, the operator server 102 may receive data corresponding to: the topic, the number of content generators, the specific content generators that should receive the invitation, the time period during which content should be created, the tags or keywords that should be associated with the content, or other information pertinent to the invitation. The invitation may be sent via email, text messaging, or any other form of communication, and may include one or more of the data received by the operator server 102. Next, the operator server 102 obtains content created by content generators in response to the request, as shown at block 404. In some embodiments, the operator server 102 is configured to receive content by various content generators—including both content created in response to the request and content created independent of a request. The operator server 102 may publish the content it receives to enable users to access the content over the Internet. The operator server may then send a copy of the content it received and published to a separate system, e.g., the Secondary System 308, as shown at block 406. While the embodiments shown in FIG. 4 have been described from the viewpoint of the operator server 102, it is contemplated that one or more steps may be performed by other systems or in conjunction with other systems, e.g., the operator computer 104.

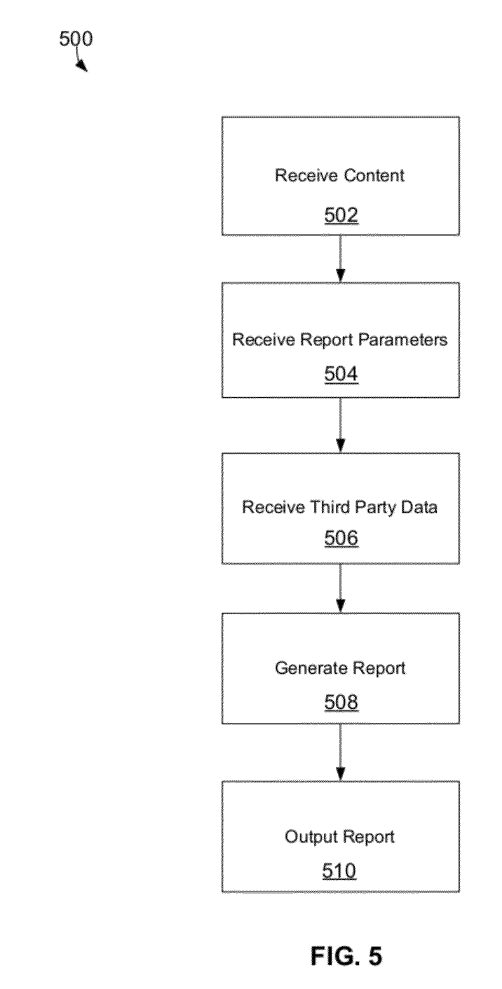

FIG. 5 illustrates an exemplary process 500 that may be performed by the Secondary System 308 according to embodiments of the invention. According to exemplary process 500, the Secondary System 308 may receive content from the operator server 102 or the Primary System 302 by direct file transfer or any other data transfer method, as shown at block 502. In other embodiments, the Secondary System 308 accesses the content over the Internet. The Secondary System 308 may also receive report parameters, e.g., periodic report parameters 310, ad hoc report parameters 312, and/or tag report parameters 313, as shown at block 504. The report parameters may be sent to the Secondary System 308 by the operator server 102 or by the operator computer 104 through direct transmission or by indirect transmission, for example, over the Internet. As discussed above, the report parameters may instruct the Secondary System 308 to create a report including specific information regarding the content created in response to a request.

In some embodiments, the Secondary System 308 also receives third-party data, which may correspond to user interactions with the content, as shown at block 506. In some embodiments, the Secondary System 308 may send a data request to a third party system, such as Facebook®, using an API. For example, the Primary System 302 or Secondary System 308 may associate the webpages hosting the content with a Facebook® page or application by using a metatag in the roots of the webpages. The Primary System 302 or Secondary System 308 then associates the webpages with a Facebook® account. Various metrics tracked and recorded by Facebook® are then made available to the Primary System 302 or Secondary System 308. In some embodiments, the operator server 102 receives the data in CSV format.

In other embodiments, a separate system, such as the operator server 102 or the operator computer 104, may send the request, receive the data, and then transmit the data to the Secondary System 308. In yet other embodiments, the Secondary System 308 may harvest the data itself, rather than receive the data from third parties.

Once the Secondary System 308 has the necessary data, it generates a report, as shown at block 508. The reporting step may include computing the efficacy of the request for content generation. The timing and/or frequency of the reporting step may be directed by the report parameters, as discussed above. In some embodiments, the Secondary System 308 is configured to identify the content created in response to a request from the tags or key words associated with that content. The Secondary System 308 may also be configured to extract information from the content and/or data corresponding to user interactions with the content. In some embodiments, the information to be extracted may be identified by the report parameters; in other embodiments, a standard set of information to be extracted may be defined within the Secondary System 308. In some embodiments, the Secondary System 308 extracts information only from the content and may append data corresponding to user interaction to the extracted information to create a report. The report may be in a CSV format or may be in any other format for later use by, for example, the sponsor or a computer system. In some embodiments, the Secondary System 308 outputs the report, as shown at block 510. The Secondary System 308 may send the report to the sponsor or may send the report to a separate computer system for further analysis. In other embodiments, the Secondary System 308 may perform further analysis on the report before outputting the report.

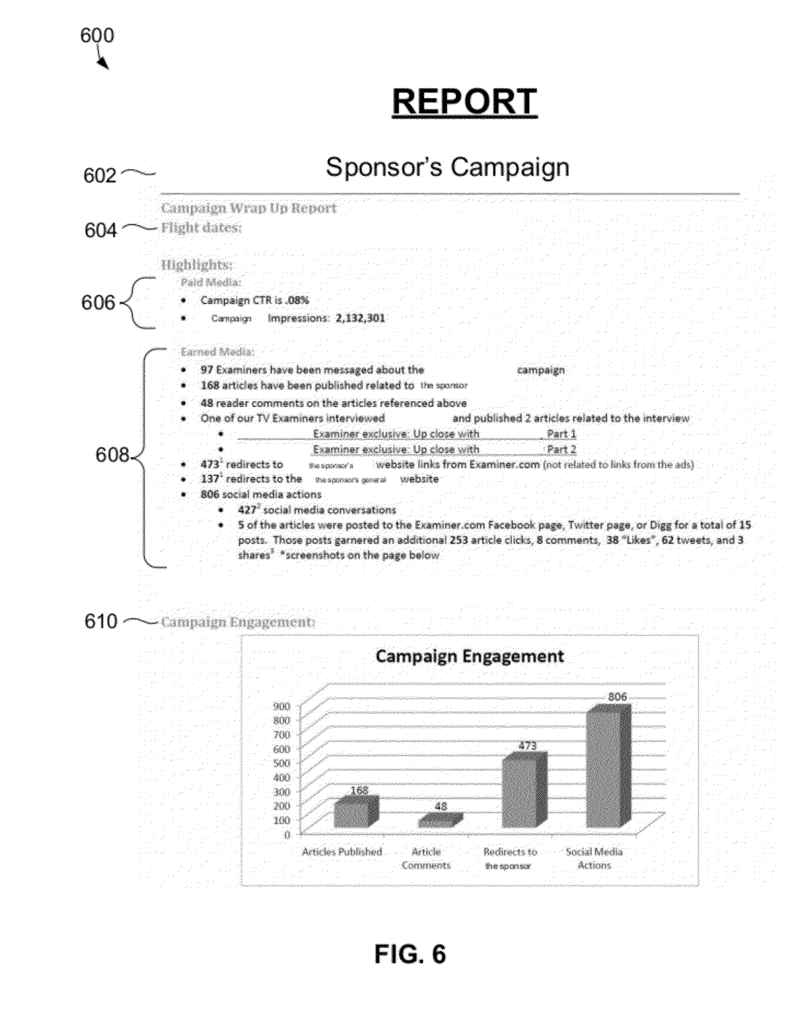

An exemplary report 600 is shown in FIG. 6. The exemplary report 600 includes information about the sponsor 602 and a date range 604. In some embodiments, the date range corresponds to the entire period in which content was created in response to a request, while in other embodiments the date range corresponds to a specific time period in which the events illustrated in the report occurred. The report 600 may include a summary of “Paid Media” 606, which involves advertisements placed alongside the content created in response to a request, and data in this category may include the CTR (click-through rate) and/or impressions (advertisement views). The exemplary report 600 may also include a summary of “Earned Media” 608, which in some embodiments includes the efficacy of the request. The Earned Media summary 608 may contain specific data extracted from the content and third party data, such as the number of content generators that received the request, the number of articles published, the number of reader comments, the number of redirects to the sponsor's webpages, or a summary of “social media action” that includes user actions on third party websites, such as Facebook®. For example, during the campaign reported in the exemplary report 600, 97 “Examiners” (i.e., content generators) received a request to create content, which resulted in the creation of 168 articles (or content). During the campaign, 48 readers (i.e., users) commented on the articles (e.g., posted a comment on the webpage containing the content). In addition, links on the webpage containing the content directed users to a particular website created by the sponsor 473 times, and links on the webpage containing the content directed users to the sponsor's general website 137 times. The report 600 also indicates that 806 social media actions occurred in conjunction with the content, including 427 social media conversations (which include blog posts, news articles, photos or videos involving the content as well as interactive comments made with respect to those blog posts, news articles, photos or videos). The report 600 further indicates that five of the articles (content) created in response to a request were posted to the Examiner.com Facebook® page, Twitter® page, or Digg® page, which garnered an additional 253 article clicks, 8 comments, 38 “likes,” 62 tweets, and 3 shares. In some embodiments, the report 600 may include charts (e.g., chart 610), excerpts from the content, and/or screen shots from social media webpages.

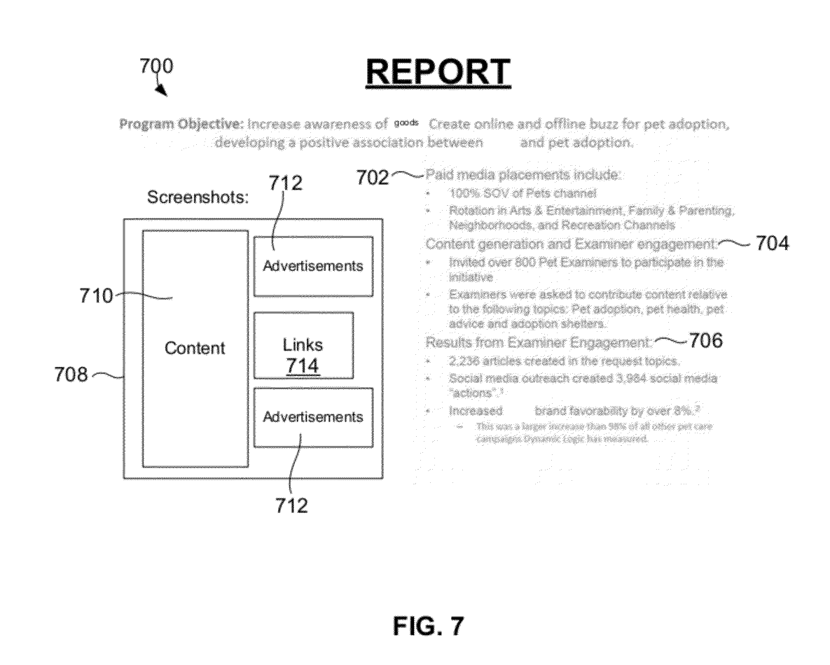

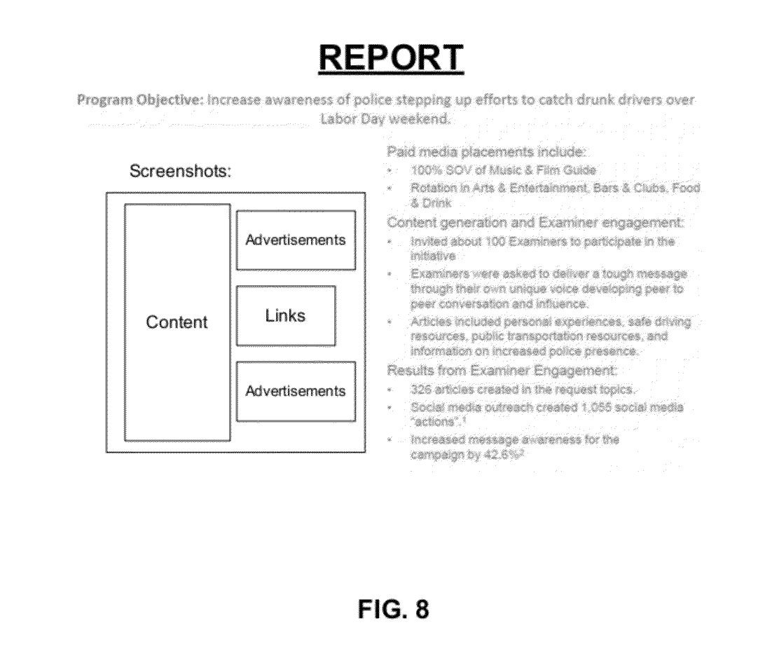

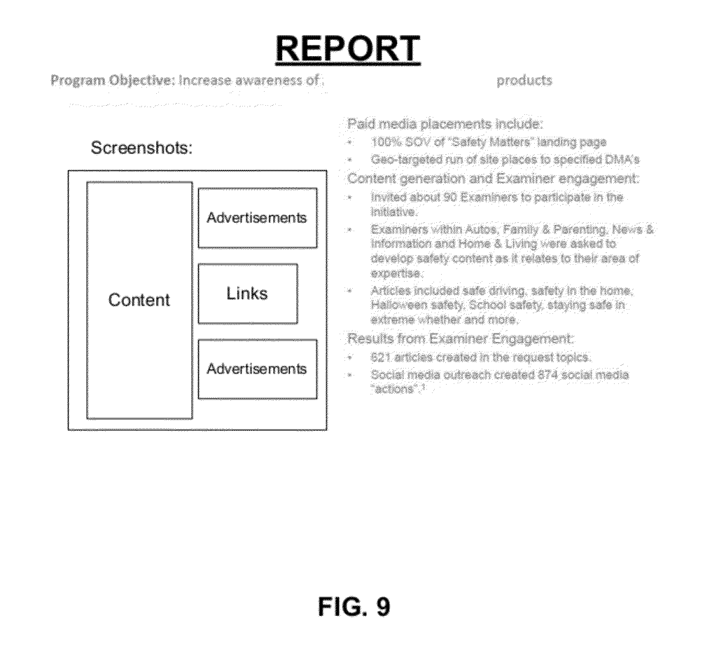

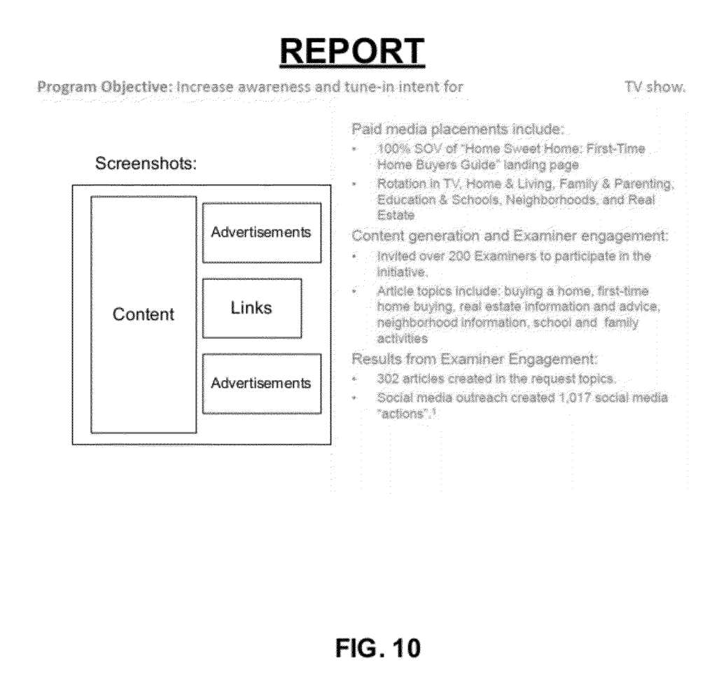

FIG. 7 depicts a report 700 according to other embodiments. In particular, report 700 includes a summary of “paid media placements” 702, which include where and how frequently paid advertisements were shown. The report 700 also includes a summary of the “content generation and Examiner [i.e., content generator] engagement” 704, which indicates the number of content generators that received a request and the topics selected, as well as a summary of “Results from Examiner Engagement,” indicating that 2,236 articles (content) were created with respect to the requested topics; 3,984 social media actions involved the content, and that the brand favorability for the sponsor increased by over 8%. The report 700 may also include an image 708 depicting a screenshot of a webpage that incorporates the content 710, along with one or more advertisements 712 and links 714 to related webpages. In other embodiments, the report 700 may include multiple images 708 of various webpages. FIGS. 8-10 include other exemplary reports containing similar information, such as metrics for increase message awareness.

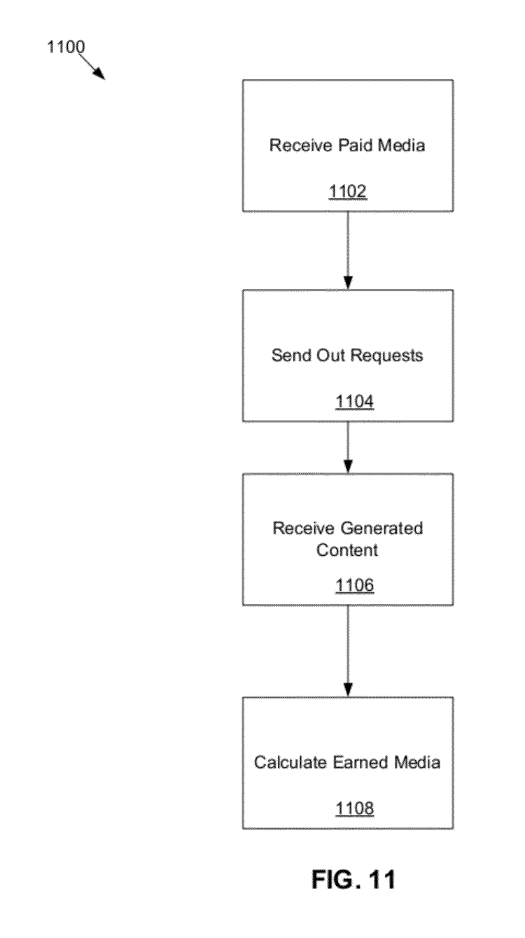

FIG. 11 illustrates an exemplary process 1100 through which embodiments of the invention enable an operator to measure “earned media.” In some embodiments, the operator is the entity executing the steps disclosed herein or the entity operating the computers/servers that execute instructions for the steps disclosed herein. For example, the operator may be a website owner desiring to incentivize and reward certain actions of the content providers who generate content for his or her website.

In this example, the operator receives advertisements, or paid media, from the sponsor, which are uploaded to a web server (e.g., operator server 102), as shown at block 1102. In other embodiments, the advertisements are created by the operator using the operator server 102 or operator computer 104 at the request of a sponsor. Along with the paid media, the operator may identify selected topics. In other embodiments, the operator identifies selected topics with sponsor assistance, or the sponsor may inform the operator of the topics that the sponsor selected. The operator and/or sponsor may also identify the report parameters, identify the relevant content generators, and provide other input for the automated system. The automated system then sends out requests to one or more content generators, as shown at block 1104, and receives content generated in response to the request, as shown at block 1106. The automated system may calculate “earned media,” as shown at block 1108. In some embodiments, that step includes generating a report depicting the parameters from which the “earned media” may be derived. In some embodiments the earned media is a specific monetary amount for each social media action (e.g., user interaction with the content on social media websites). The earned media amount may then be compared to the amount paid for the “paid media.” The operator may also refine the information contained in the report by, e.g., compiling charts, graphics, or other useful aids.

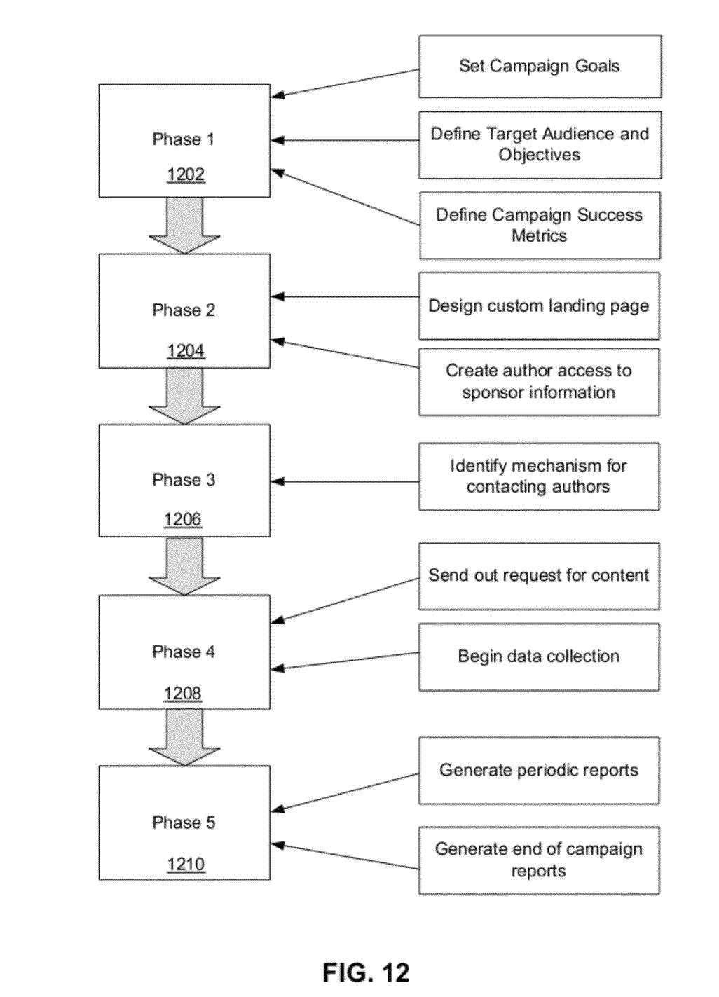

FIG. 12 illustrates an exemplary process 1200 for use with embodiments of the invention. Process 1200 is divided into five phases. The first phase 1202 involves setting campaign goals, defining a target audience and objectives, and defining campaign success metrics. Completing the first phase involves actions such as selecting the topics and configuring the report parameters. The second phase 1204 involves designing the website and identifying information that content generators may find helpful in creating the content, such as information from the sponsor or from particular experts. For example, if a selected topic involves pet food, then providing access to the sponsor's pet food may be beneficial. In the third phase 1206, the specific mechanisms for requesting content may be identified. For example, operators may configure the system to send requests via email, community pages, or social media pages. In the fourth phase 1208, the operators or operator systems may send out requests and begin the initialization of the automated processes described above. In some embodiments, this may correspond to the launch of the campaign. In the fifth phase 1210, also referred to as the “Campaign Management and Support” phase, various reports may be generated that analyze, for example, the efficacy of the requests. For example, weekly reports may track the progress of the overall campaign, and the automated process may also be used to generate an “End of campaign” report that analyzes the efficacy of the request over the entire campaign.

In some embodiments, a computer-readable medium contains instructions that cause a processor to perform many of the functions described above. The medium may include a hard drive, a disk, memory, or a transmission, among other computer-readable mediums. In addition, the computer-readable medium may include several temporally-separate components or may be one integral unit.

Various modifications and additions can be made to the embodiments discussed herein without departing from the scope of the present invention. For example, while the embodiments described above refer to particular features, the scope of this invention also includes embodiments having different combinations of features and embodiments that include different features or do not include all of the described features. Accordingly, the scope of the present invention is intended to embrace all such alternatives, modifications and variations.

We claim:

1. An automated system configured to identify an efficacy of a topical request comprising:
a requestor generator configured to generate a request to create content related to a topic;
a conveyer configured to send the request to a plurality of content generators;
a receiver configured to obtain content created in response to the request and to obtain data corresponding to user interactions with the content; and
an analyzer configured to determine an efficacy of the request based on the data corresponding to user interactions with the content.

2. The computer system of claim 1, wherein the analyzer is configured to generate a report based on the efficacy of the request.

3. The computer system of claim 1, wherein the analyzer is configured to identify the content created in response to the request using one or more keywords associated with the content.

4. The computer system of claim 1, wherein the requestor generator is configured to receive one or more request parameters and to create the request based on the one or more request parameters.

5. The computer system of claim 4, wherein the one or more request parameters include at least one content generator characteristic, and wherein the requestor generator selects the plurality of content generators to whom the invitation will be sent based on the at least one content generator characteristic.

6. The computer system of claim 1, wherein the receiver is configured to receive one or more report parameters, and wherein the analyzer is configured to identify the efficacy of the request using the one or more report parameters and the data corresponding to user interactions with the content.

7. The computer system of claim 6, further comprising an operator computer configured to transmit the one or more report parameters to the receiver.

8. A computer-implemented method for analyzing the efficacy of a topical request, comprising:
sending a request to a plurality of content generators to create content relating to a topic;
identifying the content related to the topic;
obtaining data corresponding to user interactions with the content;
calculating an efficacy of the request based on the content and the data corresponding to user interactions with the content; and
generating an analysis based on the efficacy of the request.

9. The computer-implemented method of claim 8, wherein sending the request to a plurality of content generators includes receiving one or more request parameters and generating the request based on the one or more request parameters.

10. The computer-implemented method of claim 9, wherein the one or more request parameters identify at least one characteristic of the content generators to whom the request is sent.

11. The computer-implemented method of claim 10, wherein the at least one characteristic includes an area of expertise.

12. The computer-implemented method of claim 8, further comprising obtaining data corresponding to an amount of content created in response to the request, and wherein calculating the efficacy of the request is based on the amount of content created in response to the request and on the data corresponding to user interactions with the content.

13. The computer-implemented method of claim 8, wherein the step of obtaining data corresponding to user interactions with the content includes:
obtaining data relating to user interactions with the content on a website incorporating the content; and
obtaining data relating to user interactions with the content on one or more third-party websites.

14. The computer implemented method of claim 8, wherein the step of obtaining data corresponding to user interactions with the content includes data corresponding to redirects from a website incorporating the content to one or more predetermined websites.

15. The computer-implemented method of claim 8, further comprising the step of obtaining one or more report parameters.

16. The computer-implemented method of claim 15, wherein the one or more report parameters direct when the step of calculating the efficacy occurs.

17. A computer readable medium containing instructions that cause one or more processors to perform the following:
receive one or more request parameters;
generate a request for a plurality of content generators to create content relating to a topic, based on the one or more request parameters;
receive the content related to the topic;
incorporate the content into one or more websites;
receive data corresponding to user interactions with the content;
calculate an efficacy of the request based on the content and on the data corresponding to user interactions with the content; and
generate an analysis based on the efficacy of the request.

18. The computer readable medium of claim 17, wherein generating the request to the plurality of content generators includes identifying the content generators using the one or more request parameters.

19. The computer readable medium of claim 18, wherein the instructions cause the one or more processors to store the data corresponding to user interactions with the content in a database and to store data corresponding to an amount of content created in response to the request, and wherein calculating the efficacy of the request is based on the amount of content created in response to the request and on the data corresponding to user interactions with the content.

20. The computer readable medium of claim 17, wherein the instructions further cause the one or more processors to place additional, related content on a website incorporating content created in response to the request.
